(19) United States
(12) Patent Application Publication
(10) Pub. No.: US 2009/0177704 A1
(43) Pub. Date: Jul. 9, 2009

(54) RETENTION POLICY TAGS FOR DATA ITEM EXPIRATION

(75) Inventors: Ashish Consul, Redmond, WA (US); Rajasi Saha, Sammamish, WA (US); Harvey Rook, Newcastle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/971,895

(22) Filed: Jan. 9, 2008

(51) Int. Cl. G06F 12/00

(52) U.S. Cl. 707/200; 707/E17.001

(57) ABSTRACT

Architecture for retention policy tagging of data items such as messages for expiring data items without data reorganization. Retention policy tags can be applied to items, conversations, folders, and/or distribution lists, for example. Retention policy tags provide a way to manage (e.g., expire) data items such as email, for example, and reduce the corporate burden for compliance in documents of all types. Tags can be applied to data items individually and in-place, and do not impose changes to the natural workflow of the user. The use of expiry policy tags provides a solution by removing the pain point around physically moving messages to an unfamiliar folder hierarchy.

### BACKGROUND

Data tagging is emerging as a popular mechanism for managing and organizing personal data such as email, files, photos, etc. This is true for personal management as well as organizational management of personal and corporate data.

Data tagging finds particular applicability to compliance with laws and regulations, for example. The most significant regulation for publicly-traded companies in the area of document retention is the Sarbanes-Oxley Act which defines tighter control on corporate leaders for reporting financial statements. Generally, compliance may not be a discretionary option but a mandate to retain certain electronic documents as evidence. On the other hand, there are scenarios where document retention needs to be controlled to delete data at the proper and approved time to minimize liability exposure.

Email is the primary mode of business communication and increasingly becoming an important information source for litigation. Thus, the need to reproduce email and other documents is important for the individual and the company. A burden placed on any company doing business using email is the ability to reproduce the email. One way is to meet this requirement is to archive all the email. Another way is to impose document retention policies that enable a user (e.g., an infoworker) to be able to retain email in its present state in the mailbox. However, this leads to the problem of having huge email mailboxes that continue to grow over time. Moreover, as the number and rate of incoming emails increases, the users tend to not manage by selectively filing the messages in folders. Retention policies provide a means for controlling this scenario where users do not manage documents by folders, for example, and where the company needs to retain or delete data as desired.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs retention policy tags to solve the problem of allowing users to apply tags to data (e.g., email message or other documents) to determine when the data (e.g., message) expires without needing to reorganize the data. Alternatively, or in combination therewith, the architecture not only expires the data, but also archives (e.g., makes a copy of the data to an archive location) regardless of the age of the data. Retention policy tags can be applied to items, conversations, folders, and/or distribution lists, for example.

Retention policy tags provide a way to manage (e.g., expire) data items such as email, for example, and reduce the corporate burden for compliance in documents of all types. Tags can be applied to data items individually and in-place, and do not impose changes to the natural workflow of the user. The use of expiry policy tags provides a solution by removing the pain point around physically moving messages to an unfamiliar folder hierarchy.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for managing data.

FIG. 2 illustrates a more detailed system for managing data using retention policy tags.

FIG. 3 illustrates a system that employs tagging and retention processing in a client-server environment.

FIG. 4 illustrates a client system that employs both tagging component and the retention component for retention processing of client data items.

FIG. 5 illustrates a general relationship diagram for retention policy tag processing.

FIG. 6 illustrates a computer-implemented method of managing data.

FIG. 7 illustrates a lifecycle method of a retention policy tag.

FIG. 8 illustrates a method of workflow/conflict-resolution for message expiration.

FIG. 9 illustrates an alternative computer-implemented method of managing data.

FIG. 10 illustrates a method of utilizing the expiration date of the retention policy tag for searching and sorting.

FIG. 11 illustrates a block diagram of a computing system operable to execute retention policy processing for data items in accordance with the disclosed architecture.

FIG. 12 illustrates a schematic block diagram of an exemplary computing environment for client-server retention policy tagging.

### DETAILED DESCRIPTION

In the world of data compliance (e.g., evidentiary documents) proper retention policies can reduce legal exposure. However, conventional retention techniques are problematic for the infoworker such as overcoming quota limitations for email messages, for example.

Disclosed are retention policy tags that can be applied to individual data items (e.g., messages, document types, media file types, etc.) and/or at the folder (or container) level to provide more efficient and effective management of data items. The tags include expiration information (e.g., date, duration) that can be used to determine how long to retain the items and when to delete the items. This eliminates the need to perform mass reorganization of data by allowing users to apply tags to data (e.g., email message or other documents). Retention policy tags can be applied to items, conversations, folders, and/or distribution lists, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

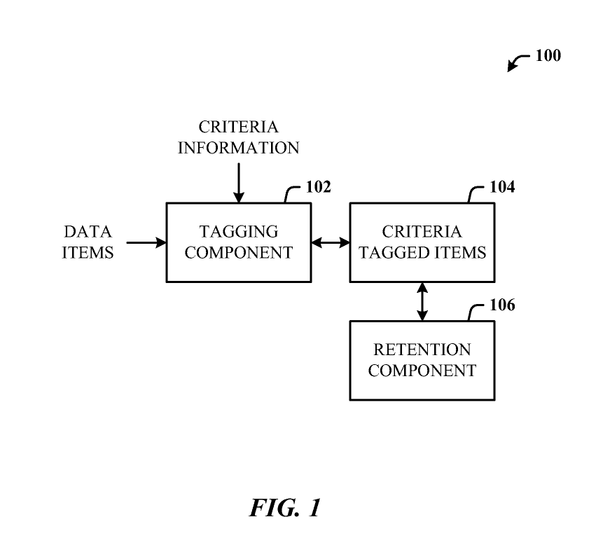

FIG. 1 illustrates a computer-implemented system 100 for managing data. The system 100 includes a tagging component 102 for tagging individual items of data with criteria tags to output criteria tagged items 104. A retention component 106 processes retention of the criteria tagged items based on the associated criteria tags. The criteria tags can include criteria information related to time, data type, size of the data, and/or other data properties, for example, that can be manually or programmatically assigned to or associated with the data items. For example, the criteria information can be expiration data that when processed cause deletion of the associated data item. In another example, the criteria information tagged to the data items can be an identifier the user defines, such as PRJ for all data items associated with a project. The user can then search for all data items with the PRJ tag for whatever purpose the user desires.

The items of data can be messages (e.g., email, SMS-short message service, MMS-multimedia messaging service, etc.) tagged with expiration tags for expiring the messages according to a time of expiration in accordance with a retention policy.

In support of the tagging component 102 allowing tagging of the data items manually by a user and/or programmatically, the tagging component 102 can reside on a client system for at least user interaction in tagging the desired data items individually, tagging folders of data items, and/or batch mode tagging for operating over many data items at one time. For example, the batch operation can be based on criteria information related to expiration time at which the data time will be expired. The tagging component 102 updates criteria information of the criteria tag based on changed circumstances associated with the corresponding item.

The retention component 106 can be a client-based entity and/or a server-based entity. When tag retention is solely on the client system, the retention component 106 also resides on the client system. For example, the client user can manually tag email messages separately with criteria tags that employ time-based expiration information as a value which can be processed for the retention or deletion of the messages according to one or more policies.

Where the retention component 106 is a server-based entity, criteria tag information can be communicated between the tagging component 102 of the client and the retention component 106 of the server such that the server processes the data items according to the policies. For example, where the criteria tag information is related to retention policies, the retention policy tag (RPT) definitions can be communicated between the client and the server.

In one implementation, RPTs determine when data items such as messages are expired. In another implementation, RPTs (or criteria tags) provide a means for managing the associated data items for purposes other than retention, such as for grouping, storing, etc.

In the context of email retention, the user can retain an original email organization scheme provided by default in the email program, customize a new organization scheme, or use both the default and custom scheme. Retention can be facilitated by the capability to expire email by applying RPTs to individual messages or folders of messages.

Other aspects of the disclosed architecture include sorting and searching of the data times (e.g., messages, audio files, etc.) based on the expiration date calculated from the RPT. The expiration date on each message indicates to the user exactly when the message expires. The system also provides realtime updating of message expiration dates and batch-mode processing of data items to expire the items as desired and configured. The expiration date can be updated in realtime in response to any relevant user action such as retagging, moving an item to another folder, etc.

An administrator can set an upper-bound on the data items or categories of data items (e.g., messages) that can be tagged with a specific retention policy tag. This is useful to the server administrator for creating a tag that allows a message to live for a long time but chooses to limit the number of such items.

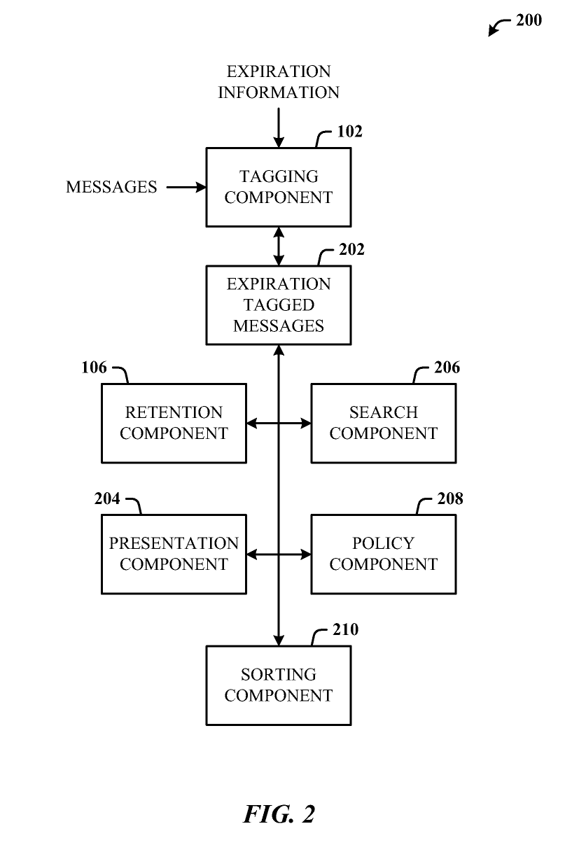

FIG. 2 illustrates a more detailed system 200 for managing data using retention policy tags. The system 200 includes the tagging component 102 for receiving expiration information and messages (the data items). The user can manually tag the messages, tag a folder of the messages, or a program can automatically tag the messages and/or folders without user intervention. The output of the tagging component 102 is expiration tagged messages 202 (also referred to as a retention policy tagged messages where the retention policy is based on the expiration information). The retention component 106 processes one or more retention policies against the expiration information in the tagged message. The policies can be defined at the user level, the organizational level, and/or corporate level, for example.

The system 200 can also include a presentation component 204 for presenting the RPTs and expiration information associated with the RPTs for user interaction therewith. A search component 206 provides the capability of searching the messages based on the expiration information in the RPTs. For example, all messages of a certain date can be searched and processed (e.g., deletion, move to a folder, etc.). A policy component 208 facilitates the generation of policies for management of the messages (the data items) via the tags for use at the user level, the organizational level (administration level), and/or corporate level, for example. The system 200 can further comprise a sorting component 210 for sorting the messages (the items) based on criteria information (e.g., expiration) associated with the criteria tags.

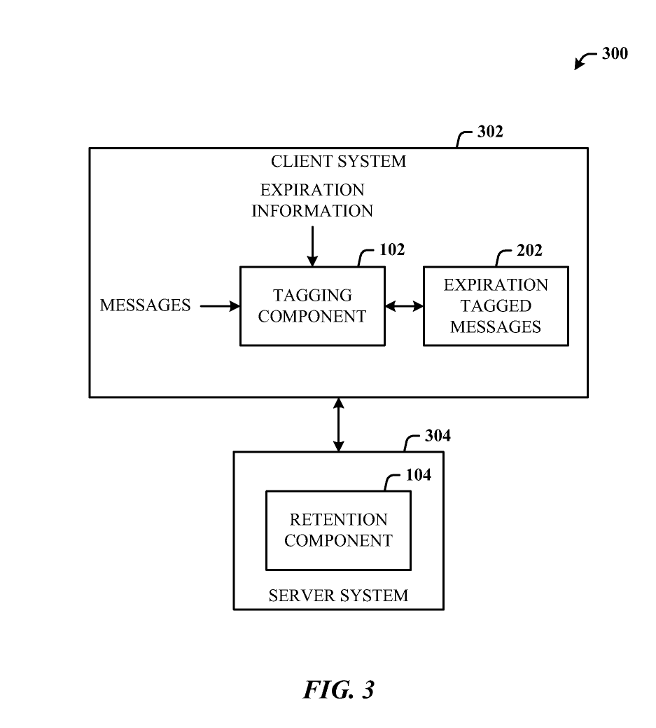

FIG. 3 illustrates a system 300 that employs tagging and retention processing in a client-server environment. Here, the tagging component 102 resides on a client system 302. The tagging component 102 can be part of a client application such as an email program where the client user can tag email messages individually and/or folders of messages with RPTs. The tagging component 102 receives data items in the form of messages, and expiration information for tagging to the messages and outputting the expiration tagged messages 202. The retention component 104 can reside on a server system 304 from which retention polices can be executed against the tagged messages 202 of the client system 302. RPT definition can be communicated between the client system 302 and the server system 304 using structures referred to as FAI (folder associated information) messages.

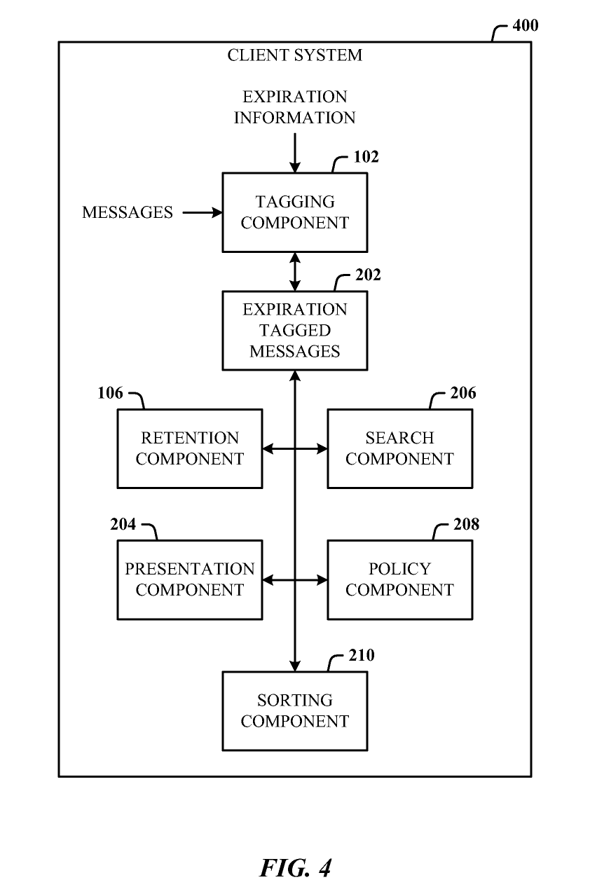

FIG. 4 illustrates a client system 400 that employs both tagging component 102 and the retention component 106 for retention processing of client data items. Although described in the context of messages as the data items to be tagged, it is to be understood that the tagging can be applied to many different types of information, such as audio data, video data, image data, text data, any or all of which can be managed by policies such as for retention. The functionality described in FIG. 2 applies here as embodied totally in the client system 400.

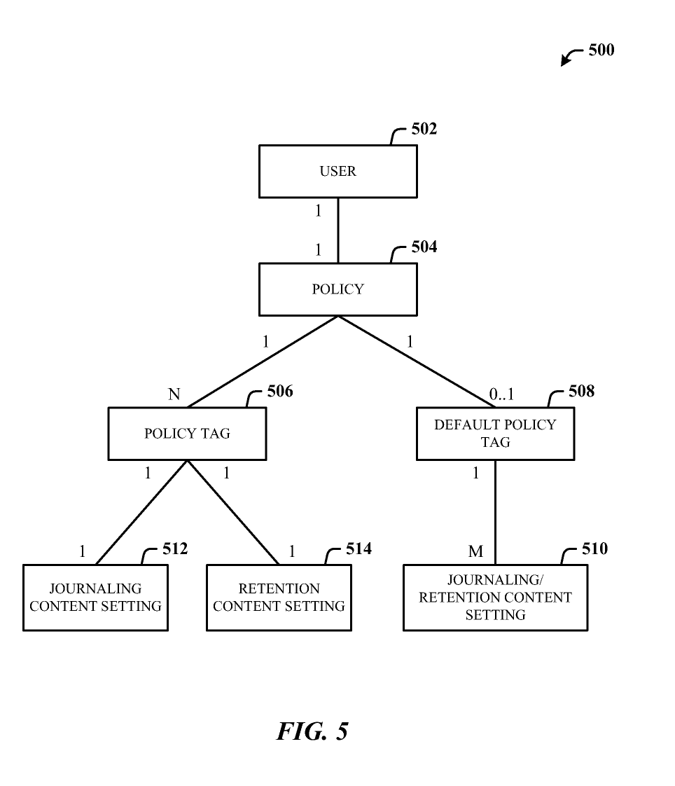

FIG. 5 illustrates a general relationship diagram 500 for retention policy tag processing. After a message, for example, is tagged explicitly by the user or implicitly by a message records management assistant (e.g., time-based (TBA), event-based (EBA)), the user knows precisely when the message will expire due to the message expiration date on each message in the mailbox. The TBA deletes the message from the mailbox on the expiry date.

The message records management EBA is responsible for keeping the message expiration date correctly updated on each message. Since the message expiration date is stamped as an attribute on each message, this information is easily visible in the client/UI and the user can sort messages and search the messages based on message expiration. The user can benefit from views that help determine when a message will expire or age out of the mailbox.

There is an associated action for each RPT—the action can be a hard delete (the message is permanently deleted), soft delete (the message can be recovered), move to another folder, or journal a message (a message is forwarded to another SMTP address, e.g., an archive gateway), for example.

The relationship diagram 500 shows that for each user 502 there is a policy 504. Inside the policy 504 there can exist N policy tags 506 and exactly one default policy tag 508. Associated with the default policy tag 508 are M journaling/retention content settings 510. Journaling involves moving the messages to another location where expiration processing can delete the messages. For example, the default policy tag 508 can be that voice mail stays in the user mailbox for a set period of time (e.g., sixty days) and thereafter, deleted. The user's normal text email can be configured for retention for one year and then is deleted.

The user is offered other choices because the settings may be insufficient for the desired purposes. Thus, associated with each policy tag 506 can be exactly one of a journaling content setting 512 which moves the message to another location (e.g., an archive). Alternatively, the policy tag 506 has exactly one retention content setting 514 which defines that for this particular kind of message, extend the retention (e.g., three years or five years or some other duration other than the default) or reduce the retention to less than the default setting.

Following is a table of exemplary item-level properties that can be employed for RPTs. Note that StartTime, Retention Period, Default Retention Period can be combined together for the consumption and conservation of message property names.

| Property Name | Type | Stamping Details | Comment |
|---|---|---|---|
| StartTime | DateTime | Stamped on every | Add the policy length |
| | | item. Server event- | to the start time to |
| | | based assistant sets | calculate expiry date. |
| | | this property. | |
| | | Message program can | |
| | | change. | |
| RetentionPeriod | Number (in | Stamped when item is | The length for |
| | days) | explicitly tagged. | keeping the item (a |
| | | Used to determine if | value of 0 or −1 means |
| | | item is explicitly | never expire). A |
| | | tagged. Message | specific value may be |
| | | program changes the | used for not-defined. |
| | | value when explicitly | |
| | | tagged. | |
| DefaultRetentionPeriod | Number | Stamped on every | The length to retain an |
| | | item by server event- | item if under the |
| | | based/time-based | default policy (can |
| | | assistant - not by | vary based on |
| | | client program. | message class) |
| RetentionDate | DateTime | Stamped on every | DateTime for item |
| | | item. Message | expiration. A |
| | | program calculates | calculated property |
| | | when cached or | when cached or |
| | | offline, server stamps | offline, and a property |
| | | when online | stamped by server |
| | | | when online. |
| Effective PolicyGUID | GUID | Stamped on every | The policy an item is |
| | | item. Message | under (either implicit |
| | | program calculates | or explicit). Open |
| | | when cached or | FAI item to display |
| | | offline, server stamps | policy name. |
| | | when online. | |

Following is a table of exemplary folder-level properties that can be employed for RPTs.

| Property Name | Type | Stamping Details | Comment |
|---|---|---|---|
| PolicyTag | GUID | Stamped on all folders. | The policy tag is a |
| | | Message program | GUID |
| | | changes when user | |
| | | explicitly tags a folder, | |
| | | and updates all subfolders | |
| | | with this tag GUID as | |
| | | well. | |
| Retention Period | Number (days) | Stamped on all folders. | The length for keeping |
| | | Message program | the item (a value of 0 or |
| | | changes when user | −1 it means never |
| | | explicitly tags a folder, | expire). |
| | | and updates all the | |
| | | subfolders with the | |
| | | retention period as well. | |
| ExplicitBit | Number (flag) | Use a new store property | The bit representing if |
| | | called RetentionFlags. | the RPT is inherited |
| | | This has the explicit bit. | from a parent. |
| | | If the least significant bit | |
| | | is 0 or if the property is | |
| | | not present, then the tag | |
| | | is implicit. | |
| | | Message program stamps | |
| | | in offline/cached mode. | |
| | | Server stamps for online | |
| | | mode. If the user tags a | |
| | | folder, explicitBit is 0 for | |
| | | each sub-folder and non- | |
| | | zero for the folder that is | |
| | | explicitly tagged. | |
| Comment | String | Not stamped on folder | Clients pick up the |
| | | | comment from the FAI |
| | | | item based on the client |
| | | | locale. |

Following are rules that can apply. RPT details such as msg_class and corresponding retention period can be retrieved from the FAI item definition. In one embodiment, folder-level tags on system folders are not allowed to be overwritten by the user. In an alternative implementation, the user can override the default policy on system folders. Item-level tags override folders tags. In other words, when a message with an explicit item-level expiry policy is moved to a folder with a folder-level policy, the item-level policy trumps the folder-level policy.

The disclosed architecture provides a precedence ordering technique for determining message expiration. Item-level tags supersede folder-level tags, and default tags apply in the absence of explicit item-level or folder-level tags. As previously indicated, for each RPT there can be up to two associated ContentSettings (one for autocopy and the other for expiration). For each default policy tag, there can be one or more associated content settings. The content settings can be determined by looking at the FAI item.

The ExplicitBit is set to one when the user manually applies a tag to the item. The bit is cleared when the user clears the tag from the item. The message program client stamps the expiry date and RPT on each item when the item does not have explicit retention tag and is moved to another folder, does not have explicit retention tag and the folder-level tag is changed, or does not have explicit retention tag and the folder is moved. The server-side EBA stamps in online or cached mode, and the client stamps in offline mode.

The following example addresses some of the conflict resolution scenarios. Consider a folder hierarchy with a top-level folder F1 and policy P1, a child folder F2 with no policy, a sub-child folder F3 (under F2) with a policy P3.

If a message with no policy is moved to folder F3, the message gets stamped with an expiration date based on policy P3. If the message is moved out of folder F3 to folder F2, folder F2 has no folder-level policy, so messages in folder F2 inherit the policy from the parent, in this case, policy P1 from folder F1. The system event-based assistant then stamps expiration information to the messages based on policy P1.

If a message is then moved out of folder F3 to folder F1, the message is stamped with the expiration date based on policy P1. Now create a new folder F4 under folder F3, and folder F4 has no folder-level expiry policy and move a message (with no assigned item-level policy) to folder F4. The message is tagged with expiration date according to the policy on folder F3 (parent/hierarchy). If policy P4 is stamped on the folder F4, the event-based assistant stamps each message in folder F4 that does not have an item-level policy, with policy P4.

Consider that the user changes policy on folder. In a first example, the folder had a folder-level policy P1 and now the policy is changed to policy P2. The event-based assistant has already stamped all messages in the folder with expiration date based on policy P1. Changing folder-level policy to policy P2 at this time results in the event-based assistant scanning all messages in the folder and stamping expiry dates based on policy P2 on all items that do not have an explicit item-level policy. In a second case, if a folder had no folder-level policy and a policy is explicitly specified on the folder, the event-based assistant will stamp the expiration date on each message that had the default or inherited policy from the parent folder with the new policy. Messages that have explicit item-level policy will not be impacted.

When a server administrator removes a policy or updates the policy such as changing the expiration time, the time-based assistant detects this change and stamps each message in the mailbox. In general, the EBA responds to changes made by the user, and the TBA responds to changes made by the server. For example, if the user moves an item to another folder that causes a change in an item policy, then the EBA will update the tag, expiration date, etc. If the administrator changes the Retention period in a policy, the TBA will update the expiration date on all items with that policy.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

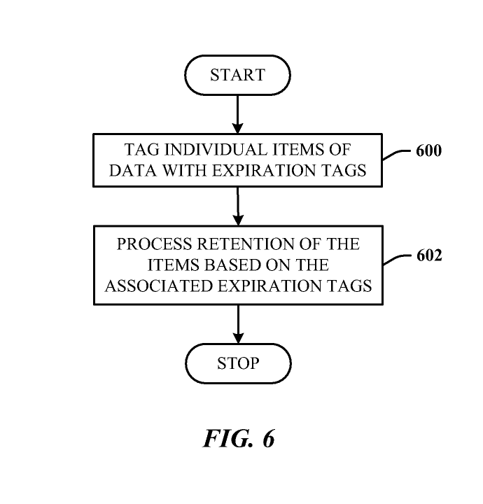

FIG. 6 illustrates a computer-implemented method of managing data. At 600, individual items of data are tagged with expiration tags. At 602, retention of the items is processed based on the associated expiration tags. As will be shown, tagging can also be performed at the folder or container level.

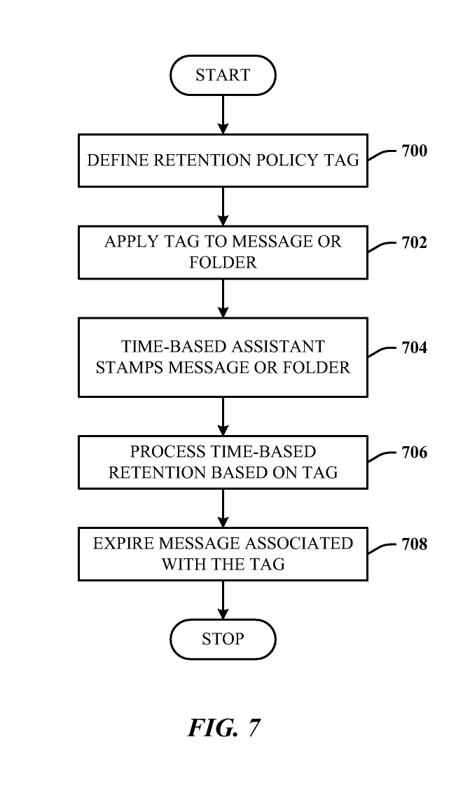

FIG. 7 illustrates a lifecycle method of a retention policy tag. At 700, the RPT is defined. For example, one or more of the RPTs can be defined by a records manager in accordance with the compliance procedures for a company. An administrator then distributes the policies to end users. At 702, an RPT is applied to the message or a folder. The end user receives the option of tagging items or folders with the RPT(s). If the user chooses not to tag the message or folders, the default expiration data applies. At 704, the first time, the time-based assistant stamps each message or folder efficiently. Availability of the message expiration information makes it possible to sort and search the messages based on the expiration information, and surface the message expiration information in the UI/client. At 706, retention of the message is processed based on the RPT. At 708, the message associated with the tag is expired. The time-based capabilities of the assistant keep the mailbox updated by periodically deleting expiring messages.

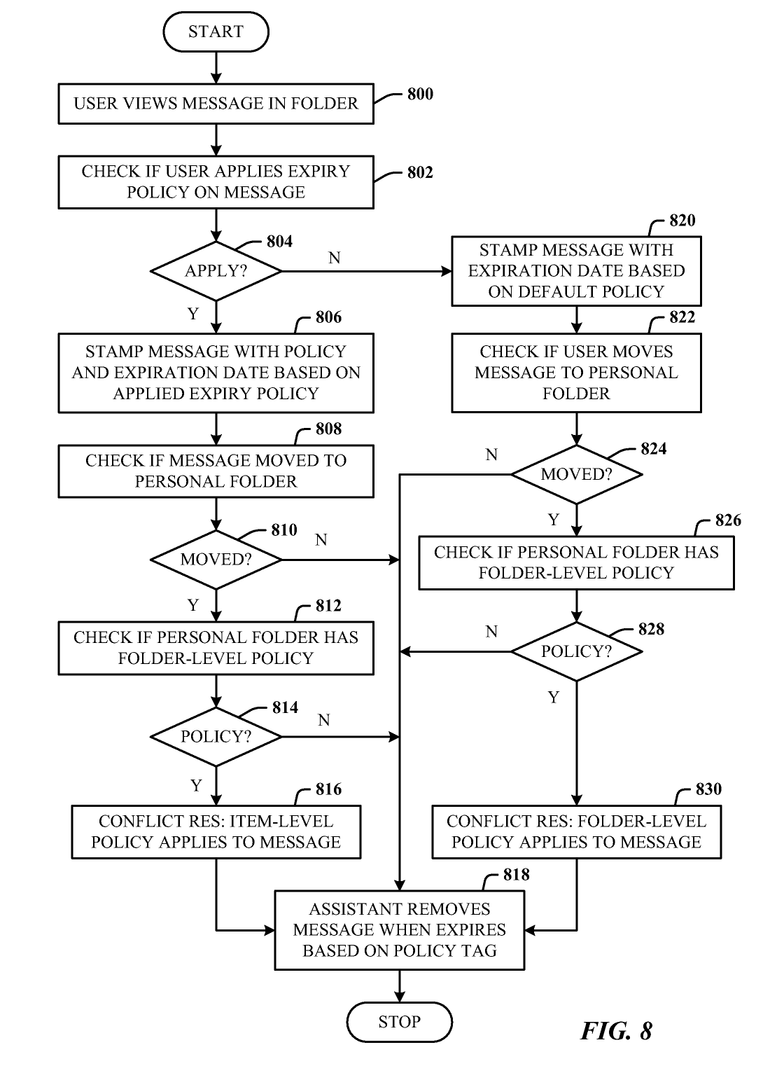

FIG. 8 illustrates a method of workflow/conflict-resolution for message expiration. With this system, users can keep the original mailbox organization and apply RPT(s) to individual messages and/or folders to enable compliance rules for the corporation and benefit from the RPT-based message expiration functionality. Moreover, the user can determine the expiration of a given message without having to learn about managed folder policies.

Generally, after a message is received at the user inbox, the message is stamped with expiration information as a property on the message. Search folders can be triggered based on the message expiration. When a user moves a message to a personal folder, if there is already a message-level expiry policy, then the message-level expiration policy applies and the expiration date property on the message is not updated since the message level policy remains unchanged. If the user has not tagged the message, then event-based assistant calculates the expiration date property based on the folder-level policy and stamps the expiration date on the message.

Returning to the flow diagram, at 800, the user views a message in a folder. At 802, the system checks if the user applies an expiry policy to the message. At 804, if applied, flow is to 806 where the policy and expiration date are stamped to the message based on the expiry policy. At 808, the system checks if the message has been moved to a personal folder. If so, at 810, the system then checks if the personal folder has a folder-level policy, as indicated at 812. If so, at 814, flow is to 816 where conflict resolution applies and the item-level policy is applied to the message. Flow is then to 818 where the assistant removes the message when the message expires based on the policy tag.

At 804, if an item-level tag has not been applied by the user, flow is to 820 where the message is stamped with an expiration date based on a default retention policy. At 822, the system checks if the user moves the message to a personal folder. At 824, if so, flow is to 826 to then check if the personal folder has a folder-level policy. If so, at 828, flow is to 830 where conflict resolution applies and the folder-level policy is applied to the message. Flow is then to 818 where the assistant removes the message when the message expires based on the policy tag. If the message has not been moved by the user to the personal folder at 810 and 824, and the personal folder does not have a folder-level policy at 814 and 828, flow is from each of 810, 814, 824 and 828 to 818 where the assistant removes the message when the message expires based on the policy tag.

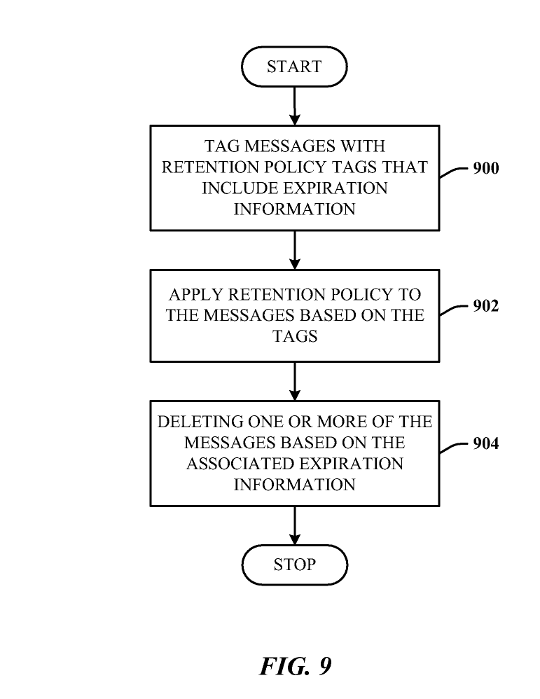

FIG. 9 illustrates an alternative computer-implemented method of managing data. At 900, messages are tagged with retention policy tags that include expiration information. At 902, a retention policy is applied to the messages based on the tags. At 904, one or more of the messages are then deleted based on the associated expiration information. Retention can work to the benefit of third-party vendor related to music downloads. For example, the downloads can be automatically tagged according to policies such that after a period of time (e.g., thirty days), the music file is deleted without user intervention, unless the user re-subscribes, or performs some other action to retain the file.

Expiration of the messages can then be prioritized based on the retention policy tags. Here, the user can be presented with a list of messages or data items that will expire in the next week, or the next 24 hours, and so on.

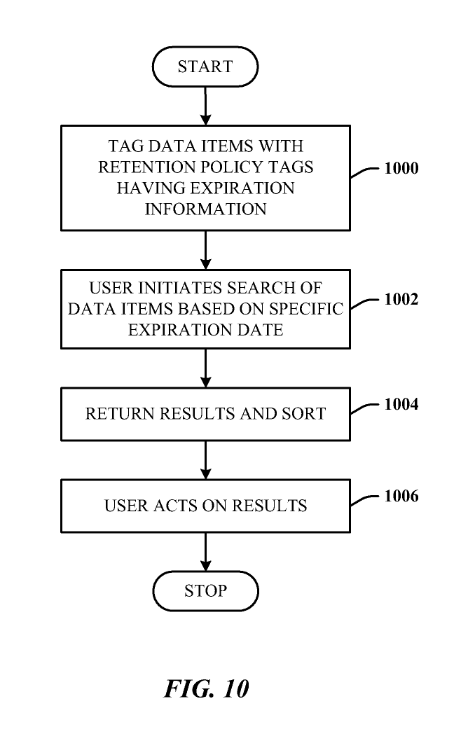

FIG. 10 illustrates a method of utilizing the expiration date of the retention policy tag for searching and sorting. At 1000, data items are tagged with retention policy tags having expiration information. This can include messages, audio files (e.g., recorded conversations), video files (e.g., video recorded meetings, etc.), images (e.g., photographs, stored images, documents captured as images or in image formats, etc.), and other documents. At 1002, the user initiates a search for all data items having a specific expiration date. At 1004, the results are returned and the results are sorted (initiated manually or automatically by a program setting). The searching and sorting can be according to the specific expiration date, all expiration dates within a certain duration of time (e.g., one week period from date A to date B), and so on. At 1006, the user can act on the results by selecting blocks of sorted data items by moving the data items into a folder or to another location, for example.

An alternative method of processing retention policy tags can include notifying the user that a set of messages (or data items) are about to be expired. If the user fails to respond, for example, by confirming expiration of the messages, the system can automatically extend the expiration date by changing the expiration information for a short period of time (e.g., three hours, days, etc.). After two attempts to receive user confirmation, the messages will then be expired.

In yet another implementation, retention can be based on the RPT plus one or more other rules. For example, a file will be expired on a certain expiration date only if the file exceeds a certain size or is of a certain file type. For example, an email is tagged for expiration, but only expired on the date if the email exceeds two megabytes and is from a certain sender. Other combinations of RPTs and rules can be processed as the user and/or administrator desires.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

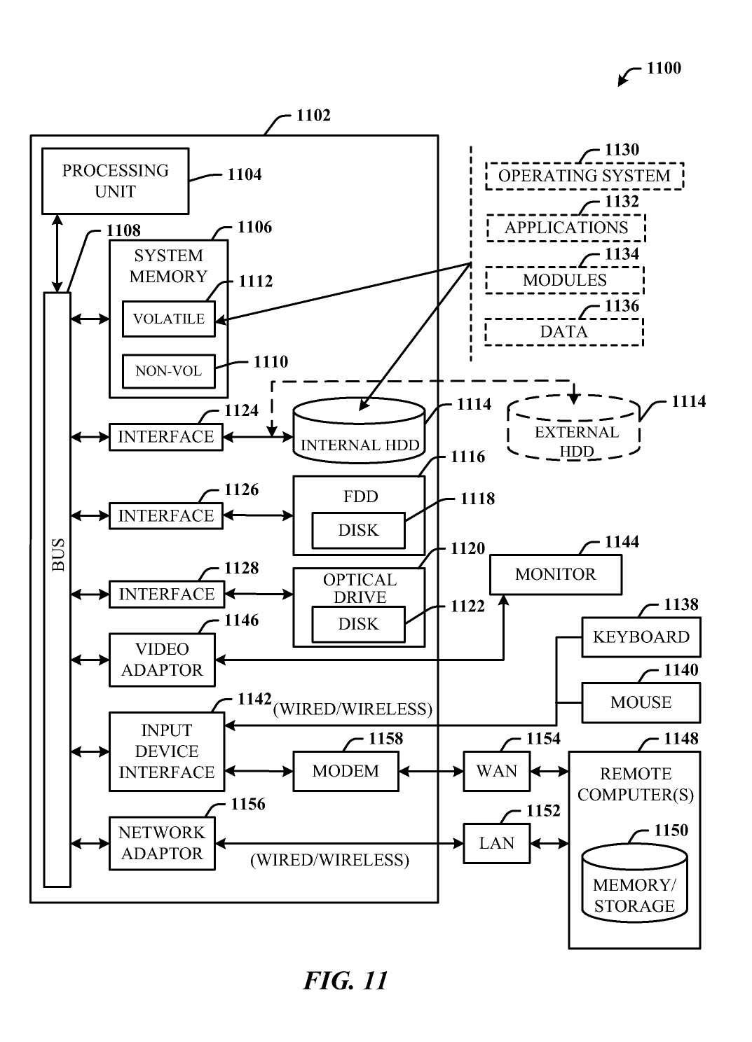

Referring now to FIG. 11, there is illustrated a block diagram of a computing system 1100 operable to execute retention policy processing for data items in accordance with the disclosed architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS stores the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include the tagging component 102, criteria tagged items 104, retention component 106 (for client-based embodiment), the expiration tagged message 202, presentation component 204, search component 206, policy component 208, sorting component 210, client system 302, and client system 400, for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

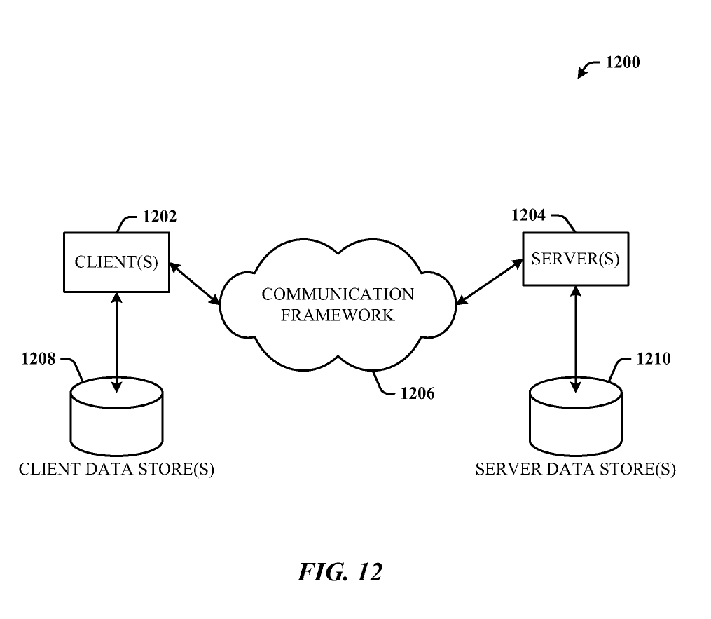

Referring now to FIG. 12, there is illustrated a schematic block diagram of an exemplary computing environment 1200 for client-server retention policy tagging. The environment 1200 includes one or more client(s) 1202. The client(s) 1202 can be hardware and/or software (e.g., threads, processes, computing devices). The client(s) 1202 can house cookie(s) and/or associated contextual information, for example.

The environment 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The environment 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The client(s) 1202 can include the client system 302 and client system 400. The server(s) 1204 can include the server 304, which further includes the retention component 104 (for the client-server embodiment).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for managing data, comprising:
a tagging component for tagging individual items of data with criteria tags; and
a retention component for processing retention of the items based on the associated criteria tags.

2. The system of claim 1, wherein the criteria tags include criteria information related to time, data type, or size of the data.

3. The system of claim 2, wherein the items of data are messages tagged with expiration tags for expiring the messages according to a time of expiration in accordance with a retention policy.

4. The system of claim 1, further comprising a presentation component for presenting the criteria tags and criteria information associated with the criteria tags for user interaction therewith.

5. The system of claim 1, further comprising a search component for searching the data items based on the criteria tags.

6. The system of claim 1, further comprising a sorting component for sorting the items based on criteria information associated with the criteria tags.

7. The system of claim 1, further comprising a policy component for generating policies for management of the data items via the criteria tags at an administration level and a user level.

8. The system of claim 1, wherein the retention component processes retention of the items on a client or on a server.

9. The system of claim 1, wherein the tagging component updates criteria information of the criteria tag based on changed circumstances associated with the corresponding item.

10. The system of claim 1, wherein the tagging component facilitates the tagging of items as a batch operation based on criteria related to expiration time.

11. A computer-implemented method of managing data, comprising:
tagging individual items of data with expiration tags; and
processing retention of the items based on the associated expiration tags.

12. The method of claim 11, further comprising applying a global policy that determines when the items are processed according to time information of the expiration tags.

13. The method of claim 11, further comprising searching and sorting the items based on the expiration tags.

14. The method of claim 11, further comprising applying an expiration tag to a folder that includes the items.

15. The method of claim 11, further comprising presenting a view of items that will expire at a future time.

16. The method of claim 11, wherein the items of data include messages, audio data, video data, image data or text data that is tagged manually or pro grammatically.

17. The method of claim 11, further comprising restricting a number of the items that can be tagged with specific time information via the expiration tags.

18. The method of claim 11, further comprising overriding a retention policy imposed in association with the expiration tags via explicit tagging of an item or a container.

19. A computer-implemented method of managing data, comprising:
tagging messages with retention policy tags that include expiration information;
applying a retention policy to the messages based on the tags; and
deleting one or more of the messages based on the associated expiration information.

20. The method of claim 19, further comprising prioritizing expiration of the messages based on the retention policy tags.
